(19) United States
(12) Patent Application Publication
(10) Pub. No.: US 2019/0205249 A1
(43) Pub. Date: Jul. 4, 2019

(54) CONTROLLER, OPERATING METHOD THEREOF AND DATA PROCESSING SYSTEM INCLUDING THE CONTROLLER

(71) Applicant: SK hynix Inc., Gyeonggi-do (KR)

(72) Inventor: Eu-Joon BYUN, Gyeonggi-do (KR)

(21) Appl. No.: 16/040,228

(22) Filed: Jul. 19, 2018

(30) Foreign Application Priority Data
Jan. 2, 2018 (KR) 10-2018-0000195

(51) Int. Cl. G06F 12/02; G06F 12/0802; G06F 3/06

(52) U.S. Cl. CPC G06F 12/0253; G06F 12/0246; G06F 12/0802; G06F 3/0608; G06F 2212/7205; G06F 3/061; G06F 3/0689; G06F 2212/7201; G06F 3/0647

(57) ABSTRACT

A controller includes: an address manager suitable for storing map data and recent access information corresponding to user data; a bitmap manager suitable for generating a bitmap indicating whether storage locations are valid, each of the storage locations respectively corresponding to a plurality of physical addresses of a memory device based on the map data and the recent access information; and a processor suitable for controlling the memory device to perform a garbage collection operation according to the bitmap.

### CROSS-REFERENCE TO RELATED APPLICATION(S)

The present application claims priority under 35 U.S.C. § 119(a) to Korean Patent Application No. 10-2018-0000195, filed on Jan. 2, 2018, the disclosure of which is incorporated herein by reference in its entirety.

### BACKGROUND

### 1. Field

Various embodiments of the present invention generally relate to an electronic device. Particularly, the embodiments relate to a controller capable of controlling a memory device and an operating method thereof.

### 2. Description of the Related Art

The computer environment paradigm is shifting towards ubiquitous computing systems that can be used anytime and anywhere. That is, use of portable electronic devices such as mobile phones, digital cameras, and laptop computers has rapidly increased. These portable electronic devices generally use a memory system having one or more memory devices for storing data. A memory system may be used as a main memory device or an auxiliary memory device of a portable electronic device.

Memory systems may provide excellent stability, durability, high information access speed, and low power consumption because they have no moving parts as compared with a hard disk device. Examples of memory systems having such advantages include universal serial bus (USB) memory devices, memory cards having various interfaces, and solid state drives (SSD).

### SUMMARY

Various embodiments are directed to a controller capable of performing efficiently garbage collection operation and an operating method thereof.

In accordance with an embodiment of the present invention, a controller may include: an address manager suitable for storing map data and recent access information corresponding to user data; a bitmap manager suitable for generating a bitmap indicating whether storage locations are valid, each of the storage locations respectively corresponding to a plurality of physical addresses of a memory device based on the map data and the recent access information; and a processor suitable for controlling the memory device to perform a garbage collection operation according to the bitmap.

In accordance with an embodiment of the present invention, an operating method of a controller may include: storing map data and recent access information corresponding to user data; generating a bitmap indicating whether a plurality of pages of a memory device are valid based on the map data and the recent access information; storing the bitmap into a virtual memory; and controlling the memory device to perform a garbage collection operation according to the bitmap.

In accordance with an embodiment of the present invention, a data processing system may include: a host including a unified memory (UM); and a memory system including a controller and a memory device having a plurality of pages, wherein the unified memory is suitable for storing a bitmap indicating validities of the plurality of pages of a memory device, wherein the controller includes: an address manager suitable for storing map data and recent access information corresponding to user data; a bitmap manager suitable for generating the bitmap indicating whether the plurality of pages are valid based on the map data and the recent access information, and storing the bitmap into the unified memory; and a processor suitable for controlling the memory device to perform a garbage collection operation according to the bitmap.

In accordance with an embodiment of the present invention, a memory system may include: a memory device including a plurality of memory blocks, including at least one memory block storing user data and at least one memory block storing map data including logical-to-physical data and physical-to-logical data; a controller suitable for generating, or updating, the map data so that the physical-to-logical data is synchronized with the logical-to-physical data, and generating, or updating, a bitmap indicating a validity regarding each physical-to-logical data value based on the map data and recent access information.

### BRIEF DESCRIPTION OF THE DRAWINGS

FIG. 1 is a block diagram illustrating a data processing system including a memory system in accordance with an embodiment of the present invention.

FIG. 2 is a schematic diagram illustrating an exemplary configuration of a memory device employed in the memory system shown in FIG. 1.

FIG. 3 is a circuit diagram illustrating an exemplary configuration of a memory cell array of a memory block in the memory device shown in FIG. 2.

FIG. 4 is a schematic diagram illustrating an exemplary three-dimensional structure of the memory device shown in FIG. 2.

FIG. 5 is a schematic diagram illustrating a structure of a controller in accordance with an embodiment of the present invention.

FIG. 6 is a flow chart describing an operation of a controller in accordance with an embodiment of the present invention.

FIGS. 7 to 15 are diagrams schematically illustrating application examples of a data processing system in accordance with one or more embodiments of the present invention.

### DETAILED DESCRIPTION

Various embodiments of the present invention are described below in more detail with reference to the accompanying drawings. It is noted, however, that the present invention may be embodied in other forms that are different than, or variations of, the disclosed embodiments. Thus, the present invention is not limited to the embodiments set forth herein. Rather, the described embodiments are provided so that this disclosure is thorough and complete and fully conveys the present invention to those skilled in the art to which this invention pertains. Throughout the disclosure, like reference numerals refer to like parts throughout the various figures and embodiments of the present invention. It is further noted that, throughout the specification, reference to “an embodiment” or the like is not necessarily to only one embodiment, and different references to “an embodiment” or the like are not necessarily to the same embodiment(s).

It will be understood that, although the terms “first”, “second”, “third”, and the like may be used herein to identify various elements, these elements are not limited by these terms. These terms are used to distinguish one element from another element that otherwise have the same or similar names. Thus, a first element described below could also be termed as a second or third element without departing from the spirit and scope of the present invention.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or connected or coupled to the latter via one or more intervening elements. In addition, it will also be understood that when an element is referred to as being “between” two elements, it may be the only element between the two elements, or one or more intervening elements may also be present.

The terminology used herein is for the purpose of describing particular embodiments and is not intended to be limiting of the present invention.

As used herein, singular forms are intended to include the plural forms and vice versa, unless the context clearly indicates otherwise.

It will be further understood that the terms “comprises,” “comprising,” “includes,” and “including” when used in this specification, specify the presence of the stated elements but do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention pertains in view of the present disclosure. It will be further understood that terms, such as those defined in commonly used dictionaries, should be interpreted as having a meaning that is consistent with their meaning in the context of the present disclosure and the relevant art and not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

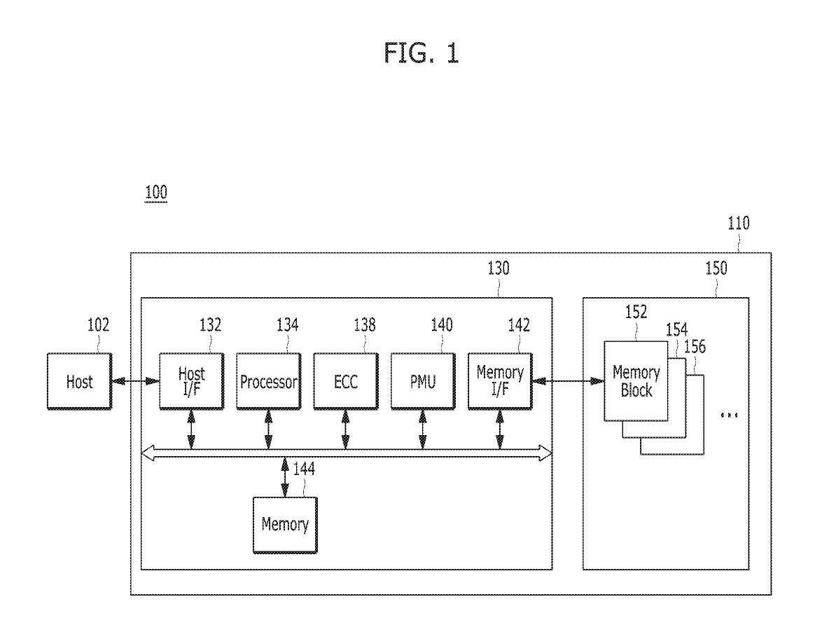

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include, for example, a portable electronic device such as a mobile phone, an MP3 player, and a laptop computer or an electronic device such as a desktop computer, a game player, a TV, a projector, and the like.

By way of example but not limitation, the memory system 110 may operate in response to a request from the host 102. For example, the memory system 110 may store data to be accessed and read by the host 102. The memory system 110 may be used as a main memory system or an auxiliary memory system of the host 102. The memory system 110 may be implemented with any one of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like.

The storage devices for the memory system 110 may be implemented with a volatile memory device such as a dynamic random access memory (DRAM) and a static RAM (SRAM), as well as with a nonvolatile memory device such as a read only memory ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM) and a flash memory.

The memory system 110 may include a memory device 150, which stores data to be accessed by the host 102, and a controller 130, which may control storage of data in the memory device 150.

The controller 130 and the memory device 150 may be integrated into a single semiconductor device, which may be included in the various types of memory systems as exemplified above.

By way of example but not limitation, the memory system 110 may be configured as a part of a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3D television, a smart television, a digital audio recorder, a digital audio player, a digital picture recorder, a digital picture player, a digital video recorder, a digital video player, a storage constituting a data center, a device capable of transmitting and receiving information under a wireless environment, one of various electronic devices of a home network, one of various electronic devices of a wired or wireless computer network, one of various electronic devices configuring a telematics network, a radio frequency identification (RFID) device, or one of various component elements which constitute a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory blocks 152, 154, 156 . . . (hereinafter, referred to as “memory blocks 152 to 156”), each of which may include a plurality of pages. Each of the pages may include a plurality of memory cells to which a plurality of word lines WL are electrically coupled.

The controller 130 may control overall operations of the memory device 150, such as read, write, program, and erase operations. By way of example but not limitation, the controller 130 of the memory system 110 may control the memory device 150 in response to a request delivered from the host 102. The controller 130 may provide the data read from the memory device 150, to the host 102, and/or may store the data, transmitted from the host 102 into the memory device 150.

The controller 130 may include a host interface (I/F) 132, a processor 134, an error correction code (ECC) unit 138, a power management unit (PMU) 140, a memory interface I/F 142 such as a NAND flash controller (NFC), and a memory 144, Each of these components may be electrically coupled to, or operatively engaged with, each other via an internal bus.

The host interface 132 may process commands and data provided from the host 102, and may communicate with the host 102 through at least one of various interface protocols such as universal serial bus (USB), multimedia card (MMC), peripheral component interconnect-express (PCI-E), small computer system interface (SCSI), serial-attached SCSI (SAS), serial advanced technology attachment (SATA), parallel advanced technology attachment (DATA), small computer system interface (SCSI), enhanced small disk interface (ESDI) and integrated drive electronics (IDE).

The ECC unit 138 may detect and correct errors in the data read from the memory device 150 during the read operation. The ECC unit 138 may not correct error bits when the number of the error bits is greater than or equal to a threshold number of correctable error bits. If not correcting error bits, the ECC unit 138 may output an error correction fail signal indicating failure in correcting the error bits.

The ECC unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and the like. The ECC unit 138 may include all circuits, modules, systems, or devices configured to perform suitable error correction operation.

The PMU 140 may provide and manage power of the controller 130.

The memory interface 142 may serve as a memory/storage interface between the controller 130 and the memory device 150 to allow the controller 130 to control the memory device 150 in response to a request from the host 102. The memory interface 142 may generate a control signal for the memory device 150 and process data to be provided to the memory device 150 under the control of the processor 134 when the memory device 150 is a flash memory and, in particular, a NAND flash memory. It is noted that the present invention is not limited to NAND flash memory/NAND flash interface, and that a suitable memory/storage interface may be selected depending upon the type of the memory device 150.

The memory 144 may serve as a working memory of the memory system 110 and the controller 130, storing data for operations of the memory system 110 and the controller 130. The controller 130 may control the memory device 150 in response to a request from the host 102. The controller 130 may provide data, read from the memory device 150 to the host 102, and may store data, provided from the host 102, into the memory device 150. The memory 144 may store data, required by the controller 130 and the memory device 150 to perform these operations.

The memory 144 may be implemented with a volatile memory. The memory 144 may be implemented with a static random access memory (SRAM) or a dynamic random access memory (DRAM). Although FIG. 1 shows the memory 144 inside controller 130, it is for illustrative purposes only; the present disclosure is not limited thereto. That is, the memory 144 may be disposed within or external to the controller 130. In another embodiment, the memory 144 may be embodied by an external volatile memory having a memory interface for transferring data between the memory 144 and the controller 130.

The processor 134 may control the overall operations of the memory system 110. The processor 134 may use firmware, which may be referred to as a flash translation layer (FTL), to control general operations of the memory system 110.

The FTL may be used as an interface between the host 102 and the memory device 150. The host 102 may request write and read operations, which may be executed through the FTL, on the memory device 150.

The FTL may manage operations of address mapping, garbage collection, wear-leveling, and so forth. Particularly, the FTL may store map data. Therefore, the controller 130 may map a logical address, which is provided from the host 102, to a physical address of the memory device 150 based on the map data. The memory device 150 may perform an operation like a general device because of the address mapping operation. When the controller 130 updates data of a particular page, the controller 130 may use an address mapping operation based on the map data to program new data into another empty page and may invalidate old data of the particular page due to a characteristic of a flash memory device. Further, the controller 130 may store map data of the new data into the FTL.

The processor 134 may be implemented with a microprocessor or a central processing unit (CPU). The memory system 110 may include one or more processors 134.

A management unit (not shown) may be included in the processor 134, and may perform bad block management of the memory device 150. The management unit may find bad memory blocks included in the memory device 150, which are in unsatisfactory condition for further use, and may perform bad block management on the bad memory blocks. When the memory device 150 is a flash memory such as a NAND flash memory, a program failure may occur during the write operation (i.e., during the program operation), due to characteristics of a NAND logic function. During the bad block management, the data in the program-failed memory block or the bad memory block may be programmed into a new memory block. Also, the bad blocks, generated due to the program fail, may seriously deteriorate the utilization efficiency of the memory device 150 having a 3D stack structure and the reliability of the memory system 100; thus, reliable bad block management is needed.

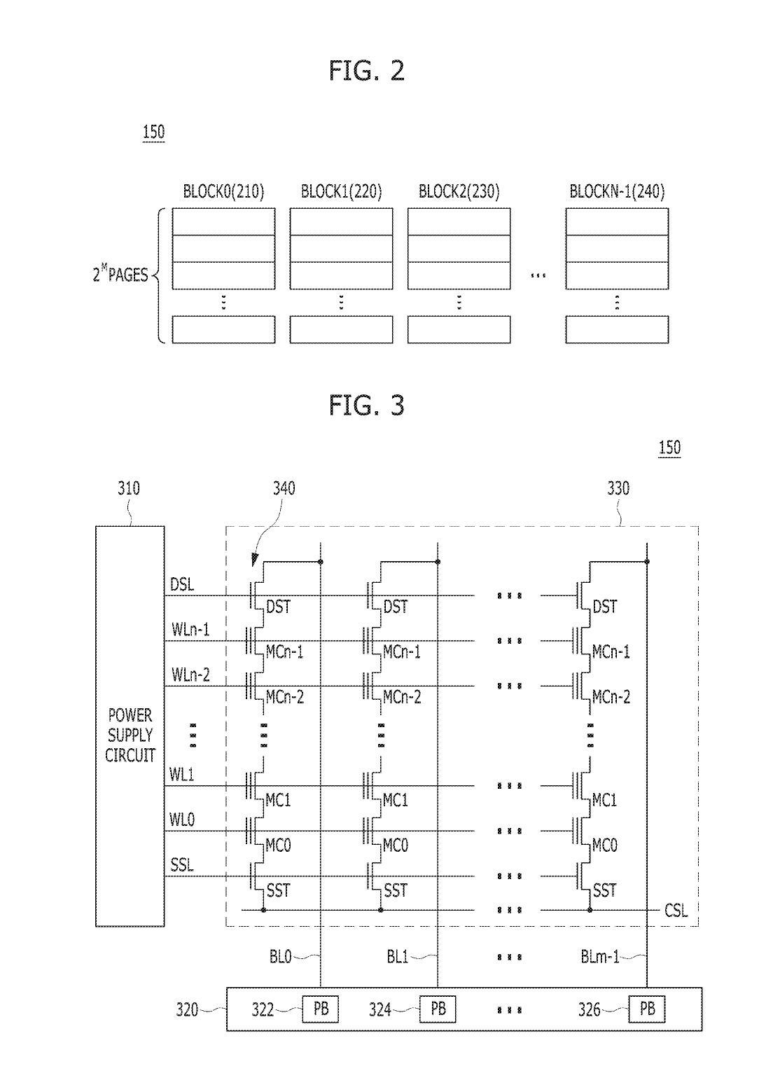

FIG. 2 is a schematic diagram illustrating the memory device 150 of FIG. 1.

Referring to FIG. 2, the memory device 150 may include a plurality of memory blocks BLOCK 0 to BLOCKN−1, each of which may include a plurality of pages, for example, 2^{M} pages, the number of which may vary according to circuit design. The memory device 150 may include a plurality of memory blocks, such as single level cell (SLC) memory blocks and/or multi-level cell (MLC) memory blocks, according to the number of bits which may be stored or expressed in a single memory cell. The SLC memory block may include a plurality of pages which are implemented with memory cells each capable of storing 1-bit data. The MLC memory block may include a plurality of pages which are implemented with memory cells each capable of storing multi-bit data, e.g., two or more-bit data. An MLC memory block including a plurality of pages which are implemented with memory cells, each capable of storing 3-bit data, may be defined as a triple level cell (TLC) memory block.

Each of the plurality of memory blocks 210 to 240 may store data provided from the host device 102 during a write operation, and may output stored data to the host 102 during a read operation.

FIG. 3 is a circuit diagram illustrating a memory block 330 in the memory device 150 of FIGS. 1 and 2.

Referring to FIG. 3, the memory block 330 may correspond to any of the plurality of memory blocks 152 to 156 shown in FIG. 1.

Referring to FIG. 3, the memory block 330 of the memory device 150 may include a plurality of cell strings 340 which are electrically coupled to bit lines BL0 to BLm−1, respectively. The cell string 340 of each column may include at least one drain select transistor DST and at least one source select transistor SST. A plurality of memory cells or a plurality of memory cell transistors MC0 to MCn−1 may be electrically coupled in series between the select transistors DST and SST. The respective memory cells MC0 to MCn−1 may be configured by single level cells (SLC), each storing 1 bit of information, and/or by multi-level cells (MLC), each storing multi-bit data. The strings 340 may be electrically coupled to the corresponding bit lines BL0 to BLm−1, respectively. For reference, in FIG. 3, ‘DSL’ denotes a drain select line, ‘SSL’ denotes a source select line, and ‘CSL’ denotes a common source line.

While FIG. 3 shows, as an example, the memory block 330 configured by NAND flash memory cells, it is to be noted that the memory block 330 is not limited to NAND flash memory. Memory block 330 may be realized by a NOR flash memory, a hybrid flash memory in which at least two kinds of memory cells are combined, or an one-NAND flash memory in which a controller is built in a memory chip. The operations of the above-described semiconductor device may be applicable not only to a flash memory device in which a charge storing layer is configured by conductive floating gates but also to a charge trap flash (CTF) in which a charge storing layer is configured by a dielectric layer.

By way of example but not limitation, a power supply circuit 310 of the memory device 150 may generate word line voltages, for example, a program voltage, a read voltage and a pass voltage, which may be selectively supplied to word lines according to an operation mode, as well as a voltage supplied to bulks. The bulks may include well regions in which the memory cells are formed. The power supply circuit 310 may perform a voltage generating operation under the control of a control circuit (not shown). The power supply circuit 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 150 may be controlled by the control circuit, and may serve as a sense amplifier or a write driver according to an operation mode. For example, during a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and supply to bit lines a voltage or a current determined according to the received data. The read/write circuit 320 may include a plurality of page buffers 322 to 326 respectively corresponding to columns (or bit lines) or column pairs (or bit line pairs). Each of the page buffers 322 to 326 may include a plurality of latches (not illustrated).

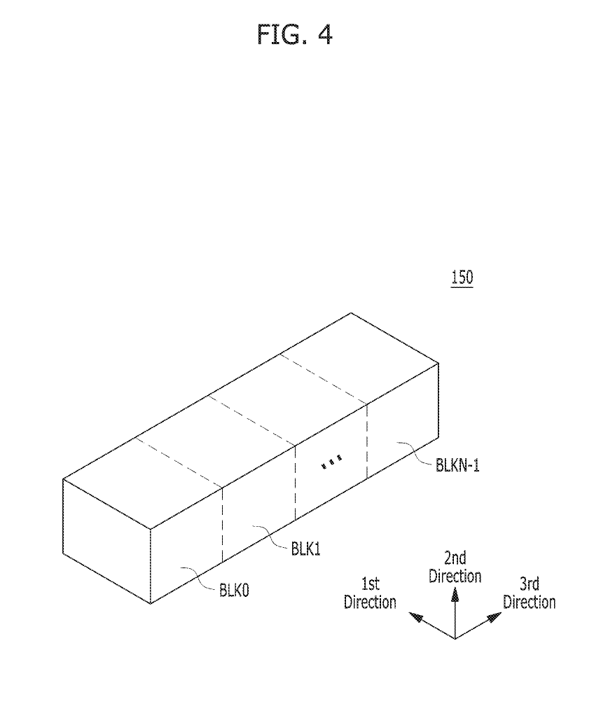

FIG. 4 is a schematic diagram illustrating a three-dimensional (3D) structure of the memory device 150 of FIGS. 1 and 2.

The memory device 150 may be embodied as a two-dimensional (2D) or a three-dimensional (3D) memory device. Specifically, as illustrated in FIG. 4, the memory device 150 may be embodied as a nonvolatile memory device having a 3D stack structure. When the memory device 150 has a 3D structure, the memory device 150 may include a plurality of memory blocks BLK0 to BLKN−1, each having a 3D structure (or vertical structure).

To identify a valid page, a memory system compares a physical address, corresponding to a location where data is stored, with a logical address provided from a host along with a command. It is assumed that a first logical address LBA1 is assigned for first data DATA1 when the first data DATA1 is to be programmed. When the first data DATA1 is programmed into a storage location corresponding to a first physical address for the first time, a controller maps the first logical address LBA1 to the first physical address. Then, when a program command for the DATA1 is asserted again, the controller controls the memory device to program the first data DATA1 into a location corresponding to a second physical address, not the first physical address, due to characteristics of NAND flash memory of the memory device. At this time, mapping information regarding the first logical address LBA1 is updated so that the LBA1 is mapped to the second physical address. Accordingly, the storage location corresponding to the first physical address is determined as an invalid page, and the storage location corresponding to the second physical address is determined as a valid page. Therefore, to identify a valid page, a memory system may check whether a physical address, corresponding to a location where data is stored, is matched with a logical address provided along with a command, and/or vice versa. Through the checking procedure, the memory system may determine that the mapping relationship between a physical address and a corresponding logical address is valid. However, determining that the mapping relationship between each physical address and each corresponding logical address is valid increases the operation time for garbage collection operation.

The operation of determining that a mapping relationship between a physical address and a corresponding logical address is valid may not be required under a condition in which the mapping relationship between the physical address and the logical address is kept unchanged and a bitmap is provided to indicate validities of storage locations, respectively corresponding to a plurality of physical addresses. However, the above-mentioned condition requires significant additional storage space.

In accordance with an embodiment of the present invention, the memory system 110 is capable of recognizing an unchanged mapping relationship between a physical address and a logical address and managing a bitmap having information (e.g., at least one bit flag, index, or the like) for showing validities of storage locations, respectively corresponding to a plurality of physical addresses. The memory system 110 may include a virtual memory 550 available for storing a bitmap of great size.

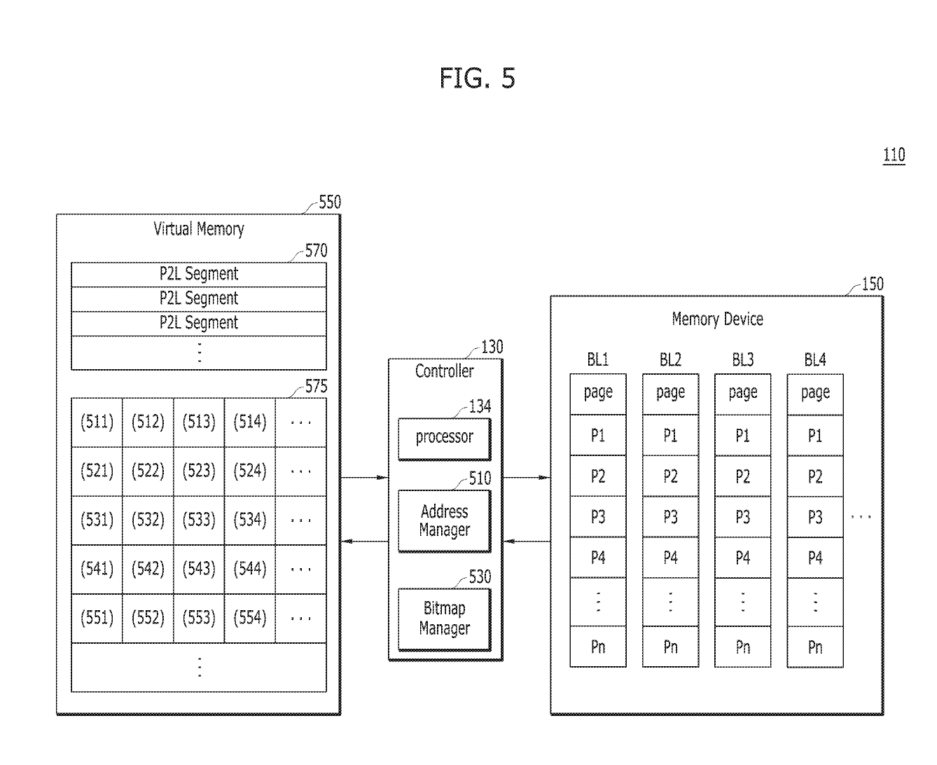

FIG. 5 is a diagram schematically illustrating a structure of the memory system 110 in accordance with an embodiment of the present invention.

The memory system 110 may include the controller 130 and the memory device 150. The memory system 110 may further include the virtual memory 550. The virtual memory 550 may be provided as a separate component, as illustrated, or may be provided in the controller 130. Although not illustrated, the virtual memory 550 may be provided in a unified memory UM of the host 102.

The memory device 150 described with reference to FIGS. 2 to 4 may include a plurality of memory blocks, each having a plurality of pages. Although not illustrated, the memory device 150 may be divided into a meta-region where map data is stored and a user region where user data is stored.

The controller 130 described with reference to FIG. 1 may include a processor 134 and may further include an address manager 510 and a bitmap manager 530. In an embodiment, the bitmap manager 530 may be configured within the processor 134, rather than as a separate component as shown in FIG. 5.

The address manager 510 may manage map data and recent access information for user data. The address manager 510 may manage a logical address for the user data and a physical address corresponding to a storage location where the user data is stored. The address manager 510 may store map data into the virtual memory 550. The address manager 510 may store into the virtual memory 550 a plurality of logical addresses and a plurality of physical addresses 570, each corresponding to a respective one of the plurality of logical addresses. The plurality of physical addresses may be managed in units of segments. When a plurality of program requests for the same data are provided, the address manager 510 may identify a physical address corresponding to a page where the same data is most recently stored. For example, when the first data DATA1 corresponding to the first logical address LBA1 is stored in a second page P2 of a first memory block BL1, the address manager 510 may manage map data for the first data DATA1 by mapping the first logical address LBA1 to the physical address indicating the second page P2 of the first memory block BL1. The address manager 510 may identify the second page P2 of the first memory block BL1 as the storage location where the first data DATA1 is most recently stored. When a program request for the first data DATA1 is provided again and the first data DATA1 is stored in a third page P3 of a second memory block BL2, the address manager 510 may update the map data to manage the map data for the first data DATA1 by mapping the first logical address LBA1 to the third page P3 of the second memory block BL2. The address manager 510 may identify the third page P3 of the second memory block BL2 as the storage location where the first data DATA1 is most recently stored. The address manager 510 may further store information of the map data and information of the physical address indicating the storage location where data is most recently stored.

The bitmap manager 530 may generate a bitmap 575 indicating whether a storage location is valid, each storage location corresponding to a respective one of the plurality of physical addresses, based on map data and recent access information stored in the address manager 510. For example, the bitmap manager 530 may set a value of ‘0’ or indicating whether the first page P1 of the first memory block BL1 is valid or not, at a corresponding first part 511 in the bitmap 575. In a similar way, the bitmap manager 530 may set a value of ‘0’ or indicating whether the second page P2 of the first memory block BL1 is valid or not, at a corresponding a second part 512 in the bitmap 575. That is, the bitmap manager 530 may generate the bitmap 575 having rows, each corresponding to a respective one of the plurality of memory blocks of the memory device 150. Each of the rows may have a plurality of bit values respectively representing the validities of the plurality of pages in a corresponding memory block. The bitmap manager 530 may generate the bitmap 575 having columns, each corresponding to a respective one of the plurality of memory blocks of the memory device 150. Each of the columns may have a plurality of bit values respectively representing the validities of the plurality of pages in a corresponding memory block. Described below is an embodiment of bitmap 575 having rows respectively corresponding to the plurality of memory blocks and the bit value of ‘1’ representing that a corresponding page is valid.

For example, when the first data DATA1 corresponding to the first logical address LBA1 is stored in the second page P2 of the first memory block BL1, the bitmap manager 530 may set a value to ‘1’ on the second part 512 corresponding to the second page P2 of the first memory block BL1 according to the map data and the recent access information stored in the address manager 510. Then, when the first data DATA1 is provided again and stored into the third page P3 of the second memory block BL2, the bitmap manager 530 may set a value to ‘1’ on a part 513 corresponding to the third page P3 of the second memory block BL2 and may set the value to ‘0’ on the second part 512 corresponding to the second page P2 of the first memory block BL1 according to the map data and the recent access information stored in the address manager 510.

The bitmap manager 530 may store the generated bitmap 575 into the virtual memory 550. The bitmap manager 530 may control the virtual memory 550 to store the generated bitmap 575 into the virtual memory 550.

The processor 134 may control the memory device 150 to store the map data, which is stored in the address manager 510, into the memory device 150 at a set frequency. In an example, the map data may be arranged in the form of units of segments of data.

Because the processor 134 can read the map data and the recent access information stored in the memory device 150 as well as temporarily store the read map data and the read recent access information into the address manager 510 periodically, the bitmap manager 530 may read the bitmap 575 stored in the virtual memory 550 and may periodically modify the bitmap 575 read from the virtual memory 550 according to the information on the logical address of user data and the recent access information stored in the address manager 510. That is, the bitmap manager 530 may periodically update the bitmap 575. Further, the bitmap manager 530 may control the virtual memory 550 to store the updated bitmap 575 into the virtual memory 550.

The processor 134 may control the memory device 150 to perform a garbage collection operation according to the bitmap 575 stored in the virtual memory 550. The processor 134 may detect a valid page based on validity information regarding a plurality of pages represented by the bitmap 575. The processor 134 may control the memory device 150 to perform a garbage collection operation with the detected valid page. When compared with a conventional garbage collection operation, the processor 134 may perform a read operation to the virtual memory 550 rather than to the memory device 150, thereby improving the performance of the memory device 150. Because a valid page is detected easily through the bitmap 575, the controller 130 may control the memory device 150 to perform a garbage collection operation effectively.

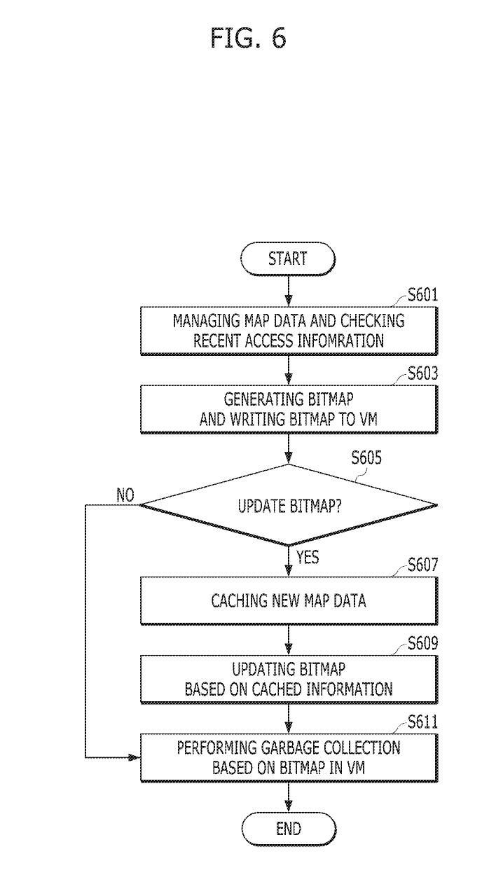

FIG. 6 is a flowchart schematically describing an operation of the controller 130 in accordance with an embodiment of the present invention.

At step S601, the address manager 510 may manage the mapping relationship between the logical address corresponding to input user data and the physical address corresponding to a storage location where the input user data is stored, that is, map data corresponding to the input user data. When a plurality of program requests for the same data are provided, the address manager 510 may identify a physical address corresponding to a page where the same data is most recently stored.

At step S603, the bitmap manager 530 may generate the bitmap 575 showing or indicating validities of storage locations, each corresponding to respective one of the plurality of physical addresses, based on the map data and the recent access information stored in the address manager 510. The bitmap manager 530 may store the generated bitmap 575 into the virtual memory 550.

At step S605, the bitmap manager 530 may determine whether to update the bitmap 575. As described above with reference to FIG. 5, since the processor 134 periodically updates the map data, the bitmap 575 may also be updated to update validities of data stored in the memory device 150.

When the bitmap 575 is to be updated (“YES” at step S605), the address manager 510 may cache new map data at step S607. The address manager 510 may cache the map data and the recent access information stored in the memory device 150, which are a target of the update.

At step S609, the bitmap manager 530 may update the bitmap 575. The processor 134 may read the bitmap 575 stored in the virtual memory 550 and may modify the bitmap 575 read from the virtual memory 550 according to the map data and the recent access information cached in the address manager 510. Further, the bitmap manager 530 may control the virtual memory 550 to store the updated bitmap 575 again into the virtual memory 550.

When the bitmap 575 is not to be updated (“NO” at step S605), step S611 may be performed.

At step S611, the processor 134 may control the memory device 150 to perform a garbage collection operation according to the bitmap 575 stored in the virtual memory 550.

In accordance with an embodiment of the present invention, the virtual memory 550 as a separate storage space rather than the memory device 150 may store the bitmap 575 representing the validities of storage locations respectively corresponding to the plurality of physical addresses of the memory device 150. In accordance with an embodiment of the present invention, during a garbage collection operation, the controller 130 may detect a valid page according to the bitmap 575 stored in the virtual memory 550 rather than detecting a valid page by controlling the memory device 150 to read data from the memory device 150, thereby reducing workload of the memory device 150. Therefore, the performance of the memory device 150 may be improved and efficiency of a garbage collection operation of the controller 130 may be improved.

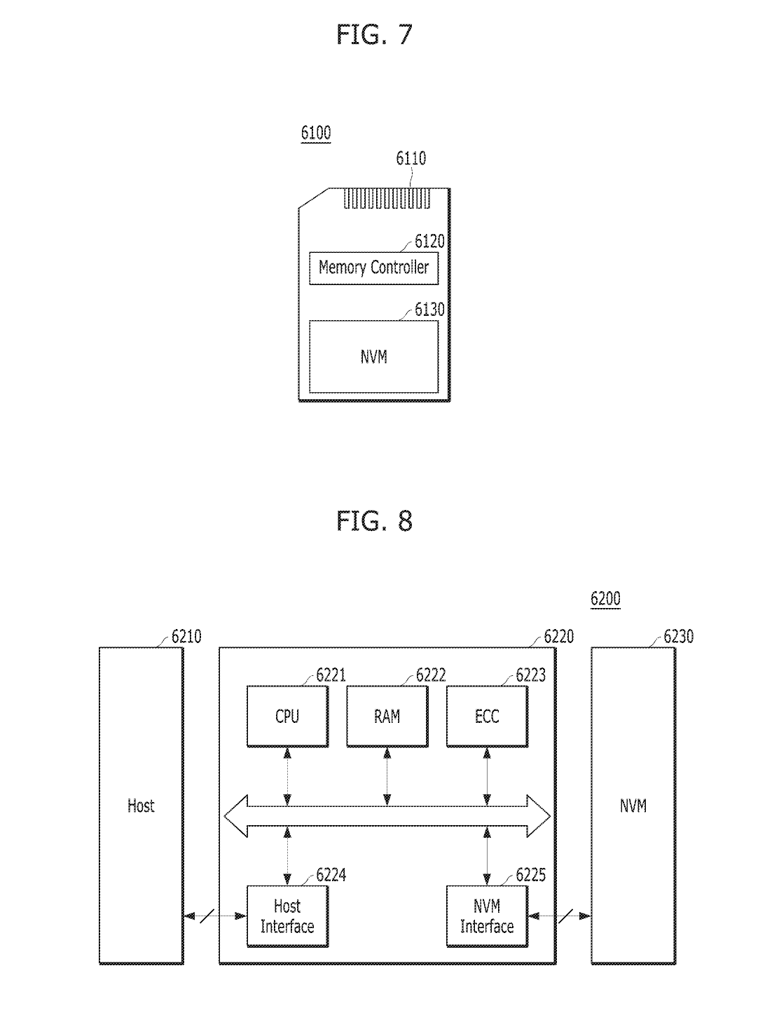

FIGS. 7 to 15 are diagrams schematically illustrating application examples of the data processing system of FIGS. 1 to 6 according to various embodiments.

FIG. 7 is a diagram schematically illustrating an example of the data processing system including the memory system in accordance with an embodiment. FIG. 7 schematically illustrates a memory card system to which the memory system in accordance with an embodiment is applied.

Referring to FIG. 7, the memory card system 6100 may include a memory controller 6120, a memory device 6130, and a connector 6110.

More specifically, the memory controller 6120, configured to access the memory device 6130, may be electrically connected to the memory device 6130 embodied by a nonvolatile memory. For example, the memory controller 6120 may be configured to control read, write, erase and background operations of the memory device 6130. The memory controller 6120 may be configured to provide an interface between the memory device 6130 and a host, and to use firmware for controlling the memory device 6130. That is, the memory controller 6120 may correspond to the controller 130 of the memory system 110 described with reference to FIGS. 1 to 6, while the memory device 6130 may correspond to the memory device 150 of the memory system 110 described with reference to FIGS. 1 to 6.

Thus, the memory controller 6120 may include a RAM, a processor, a host interface, a memory interface and an error correction unit. The memory controller 130 may further include the elements described in FIG. 1.

The memory controller 6120 may communicate with an external device, for example, the host 102 of FIG. 1 through the connector 6110. By way of example but not limitation, as described with reference to FIG. 1, the memory controller 6120 may be configured to communicate with an external device according to one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with an embodiment may be applied to wired/wireless electronic devices, particularly mobile electronic devices.

The memory device 6130 may be implemented by a nonvolatile memory. By way of example but not limitation, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and/or a spin torque transfer magnetic RAM (STT-RAM). The memory device 6130 may include a plurality of dies as in the memory device 150 of FIG. 1.

The memory controller 6120 and the memory device 6130 may be integrated into a single semiconductor device. For example, the memory controller 6120 and the memory device 6130 may be so integrated to form a solid state driver (SSD). Also, the memory controller 6120 and the memory device 6130 may form a memory card such as a PC card (PCMCIA: Personal Computer Memory Card International Association), a compact flash (CF) card, a smart media card (e.g., SM and SMC), a memory stick, a multimedia card (e.g., MMC, RS-MMC, MMCmicro and eMMC), an SD card (e.g., SD, miniSD, microSD and SDHC), and/or a universal flash storage (UFS).

FIG. 8 is a diagram schematically illustrating an example of the data processing system including a memory system in accordance with an embodiment.

Referring to FIG. 8, the data processing system 6200 may include a memory device 6230 having one or more nonvolatile memories and a memory controller 6220 for controlling the memory device 6230. The data processing system 6200 illustrated in FIG. 8 may serve as a storage medium such as a memory card (CF, SD, micro-SD or the like) or USB device, as described with reference to FIG. 1. The memory device 6230 may correspond to the memory device 150 in the memory system 110 described in FIGS. 1 to 6, while the memory controller 6220 may correspond to the controller 130 in the memory system 110 described in FIGS. 1 to 6.

The memory controller 6220 may control a read, write or erase operation on the memory device 6230 in response to a request of the host 6210. The memory controller 6220 may include one or more CPUs 6221, a buffer memory such as RAM 6222, an ECC circuit 6223, a host interface 6224 and a memory interface such as an NVM interface 6225.

The CPU 6221 may control the operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted between the memory device 6230 and the host 6210. When the RAM 6222 is used as a cache memory, the RAM 6222 may assist the low-speed memory device 6230 to operate at high speed.

The ECC circuit 6223 may correspond to the ECC unit 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. The ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit to, or receive from, the host 6210 data through the host interface 6224, and transmit to, or receive from, the memory device 6230 data through the NVM interface 6225. The host interface 6224 may be connected to the host 6210 through a PATA bus, SATA bus, SCSI, USB, PCIe or NAND interface. The memory controller 6220 may achieve a wireless communication function with a mobile communication protocol such as WiFi or Long Term Evolution (LTE). The memory controller 6220 may be connected to an external device, e.g., the host 6210 or another external device, and then transmit/receive data to/from the external device. As the memory controller 6220 is configured to communicate with the external device through one or more of various communication protocols, the memory system and the data processing system in accordance with an embodiment may be applied to a wired/wireless electronic device, particularly, a mobile electronic device.

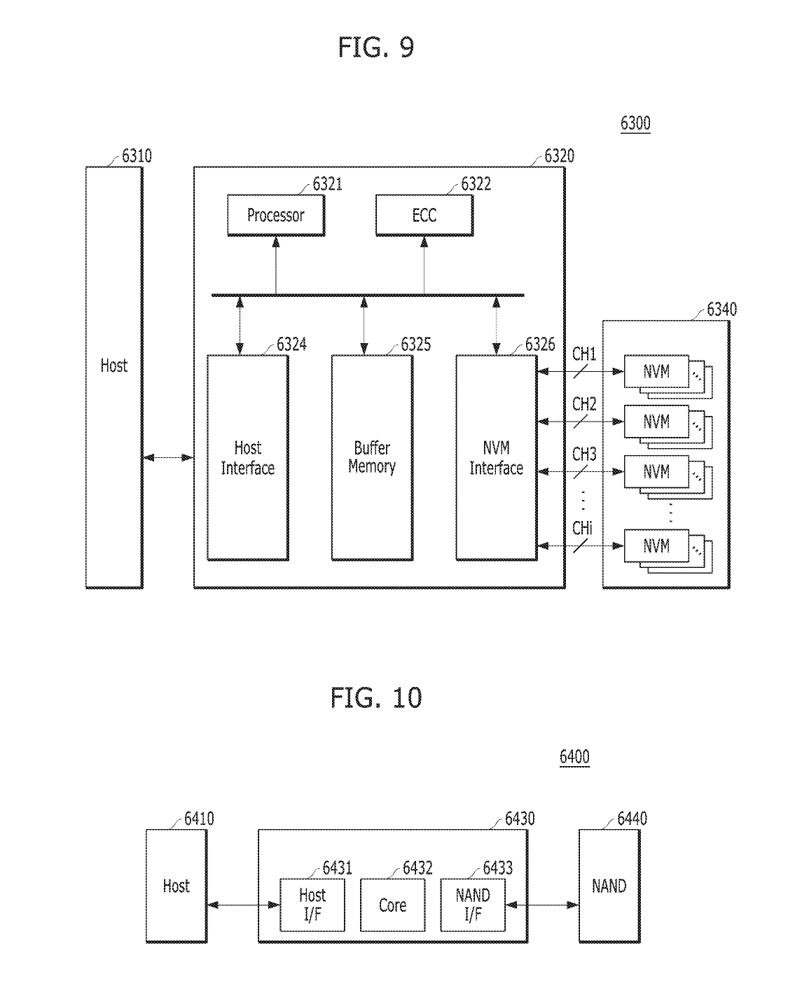

FIG. 9 is a diagram schematically illustrating an example of the data processing system including the memory system in accordance with an embodiment. FIG. 9 schematically illustrates an SSD to which the memory system may be applied.

Referring to FIG. 9, the SSD 6300 may include a controller 6320 and a memory device 6340 including a plurality of nonvolatile memories. The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface such as a nonvolatile memory interface 6326.

The buffer memory 6325 may temporarily store data provided from the host 6310 or data provided from a plurality of flash memories NVM in the memory device 6340. Further, the buffer memory 6325 may temporarily store meta data of the plurality of flash memories NVM, for example, map data including a mapping table. The buffer memory 6325 may be embodied by volatile memories such as DRAM, SDRAM, DDR SDRAM, LPDDR SDRAM and GRAM or nonvolatile memories such as FRAM, ReRAM, STT-MRAM and PRAM. FIG. 9 illustrates that the buffer memory 6325 is embodied in the controller 6320. However, the buffer memory 6325 may be external to the controller 6320.

The ECC circuit 6322 may calculate an ECC value of data to be programmed to the memory device 6340 during a program operation. The ECC circuit 6322 may perform an error correction operation on data read from the memory device 6340 based on the ECC value during a read operation. The ECC circuit 6322 may perform an error correction operation on data recovered from the memory device 6340 during a failed data recovery operation.

The host interface 6324 may provide an interface function with an external device such as the host 6310. The nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, e.g., RAID (Redundant Array of Independent Disks) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300, according to a plurality of RAID levels, i.e., RAID level information of the write command provided from the host 6310 in the SSDs 6300, to output data corresponding to the write command to the selected SSDs 6300. Furthermore, when the RAID controller performs a read command in response to a read command provided from the host 6310, the RAID controller may select one or more memory systems or SSDs 6300, according to a plurality of RAID levels, i.e., RAID level information of the read command provided from the host 6310 in the SSDs 6300, to output data read from the selected SSDs 6300 to the host 6310.

FIG. 10 is a diagram schematically illustrating an example of the data processing system including the memory system in accordance with an embodiment. FIG. 10 schematically illustrates an embedded Multi-Media Card (eMMC) to which the memory system may be applied.

Referring to FIG. 10, the eMMC 6400 may include a controller 6430 and a memory device 6440 embodied by one or more NAND flash memories. The controller 6430 may correspond to the controller 130 in the memory system 110 of FIG. 1. The memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface 6431 and a memory interface such as a NAND interface 6433.

The core 6432 may control the operations of the eMMC 6400. The host interface 6431 may provide an interface function between the controller 6430 and the host 6410. The NAND interface 6433 may provide an interface function between the memory device 6440 and the controller 6430. By way of example but not limitation, the host interface 6431 may serve as a parallel interface such as MMC interface as described with reference to FIG. 1. Furthermore, the host interface 6431 may serve as a serial interface, for example, UHS ((Ultra High Speed)-I/UHS-II) interface.

FIGS. 11 to 14 are diagrams schematically illustrating other examples of the data processing system including the memory system in accordance with an embodiment. FIGS. 11 to 14 schematically illustrate UFS (Universal Flash Storage) systems to which the memory system may be applied.

Referring to FIGS. 11 to 14, the UFS systems 6500, 6600, 6700, 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired/wireless electronic devices or particularly mobile electronic devices, the UFS devices 6520, 6620, 6720, 6820 may serve as embedded UFS devices, and the UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700, 6800 may communicate with external devices such as wired/wireless electronic devices, particularly, mobile electronic devices through UFS protocols, and the UFS devices 6520, 6620, 6720, 6820 and the UFS cards 6530, 6630, 6730, 6830 may be embodied by the memory system 110 illustrated in FIG. 1. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 8 to 10, and the UFS cards 6530, 6630, 6730, 6830 may be embodied in the form of the memory card system 6100 described with reference to FIG. 7.

Furthermore, in the UFS systems 6500, 6600, 6700, 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through various protocols other than the UFS protocol, for example, UFDs, MMC, SD, mini-SD, and micro-SD.

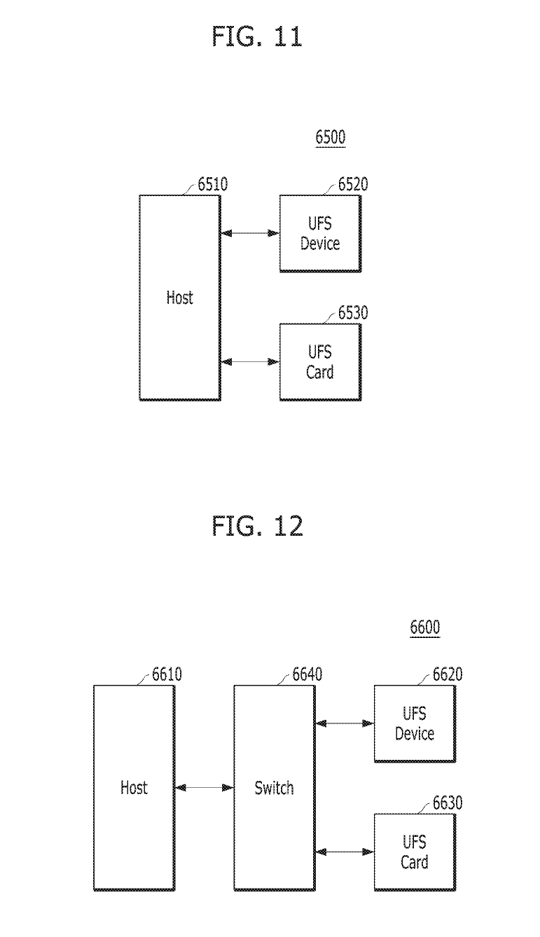

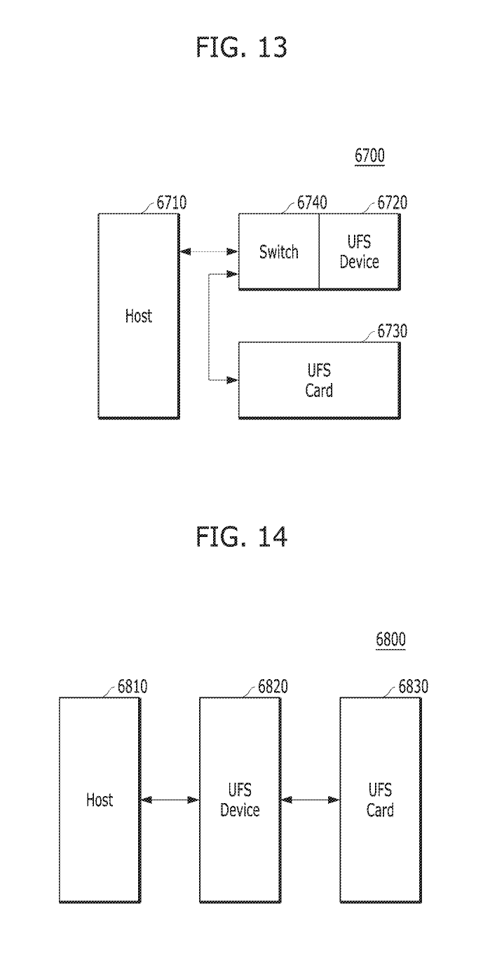

In the exemplary systems shown in FIGS. 12 and 13, switches 6640, 6740 are provided. The switches 6640, 6740 may interface between hosts 6610, 6710 and UFS cards 6630, 6730 respectively. The switches 6640, 6740 may also interface between their respective hosts 6610, 6710 and their respective UFS devices 6620, 6720. In the system of FIG. 13, the switch 6740 may be formed, or in contact, with the UFS device 6720.

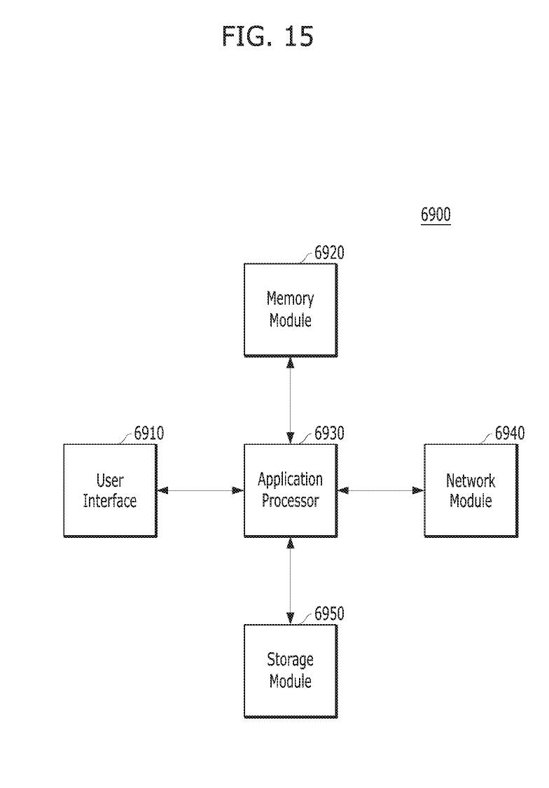

FIG. 15 is a diagram schematically illustrating another example of the data processing system including the memory system in accordance with an embodiment. FIG. 15 is a diagram schematically illustrating a user system to which the memory system may be applied.

Referring to FIG. 15, the user system 6900 may include an application processor 6930, a memory module 6920, a network module 6940, a storage module 6950, and a user interface 6910.

More specifically, the application processor 6930 may control or drive components in the user system 6900 such as an operating system (OS). The application processor 6930 may include controllers, interfaces and a graphic engine which are capable of controlling the components included in the user system 6900. The application processor 6930 may be provided as a System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM, or a nonvolatile RAM such as PRAM, ReRAM, MRAM or FRAM. By way of example but not limitation, the application processor 6930 and the memory module 6920 may be packaged and mounted, based on POP (Package on Package).

The network module 6940 may communicate with external devices. For example, the network module 6940 may support wired communication as well as various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices, particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied in a nonvolatile semiconductor memory device such as a phase-change RAM (PRAM), a magnetic RAM (MRAM), a resistive RAM (ReRAM), a NAND flash, NOR flash and/or 3D NAND flash. The storage module 6950 may be provided with a removable storage medium such as a memory card or external drive of the user system 6900. The storage module 6950 may correspond to the memory system 110 described with reference to FIG. 1. Furthermore, the storage module 6950 may be embodied in an SSD, eMMC and UFS as described above with reference to FIGS. 9 to 14.

The user interface 6910 may include interfaces for inputting data or commands to the application processor 6930 or outputting data to an external device. By way of example but not limitation, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and/or a motor.

Furthermore, when the memory system 10 of FIG. 1 is applied to a mobile electronic device of the user system 6900, the application processor 6930 may control the operations of the mobile electronic device, and the network module 6940 may serve as a communication module for controlling wired/wireless communication with an external device. The user interface 6910 may display data processed by the processor 6930 on a display/touch module of the mobile electronic device, or support a function of receiving data from the touch panel.

While the present invention has been described with respect to specific embodiments, it will be apparent to those skilled in the art in light of the foregoing description that various changes and modifications may be made without departing from the spirit and scope of the invention as defined in the following claims.

What is claimed is:

1. A controller comprising:
an address manager suitable for storing map data and recent access information corresponding to user data;
a bitmap manager suitable for generating a bitmap indicating whether storage locations are valid, each of the storage locations respectively corresponding to a plurality of physical addresses of a memory device based on the map data and the recent access information; and
a processor suitable for controlling the memory device to perform a garbage collection operation according to the bitmap.

2. The controller of claim 1, wherein the processor is further suitable for periodically flushing new map data into the memory device.

3. The controller of claim 2,
wherein the address manager is further suitable for caching the new map data into therein, and
wherein the bitmap manager is further suitable for updating the bitmap according to the new map data.

4. The controller of claim 1, wherein the bitmap manager is suitable for generating the bitmap setting a value of ‘1’ for a valid page.

5. The controller of claim 2, wherein the processor is further suitable for flushing the map data in units of segments.

6. The controller of claim 1, wherein the processor is further suitable for controlling the memory device to:
select a victim memory block, among a plurality of memory blocks in the memory device, having a smaller number of valid pages than a threshold based on the bitmap; and
copy valid data stored in the victim memory block into a free memory block of the plurality of memory blocks.

7. The controller of claim 1, wherein the bitmap manager is suitable for generating the bitmap such that rows of the bitmap respectively correspond to a plurality of memory blocks of the memory device.

8. The controller of claim 1, wherein the bitmap manager is suitable for generating the bitmap such that columns of the bitmap respectively correspond to a plurality of memory blocks of the memory device.

9. An operating method of a controller, the method comprising:
storing map data and recent access information corresponding to user data;
generating a bitmap indicating whether a plurality of pages of a memory device are valid based on the map data and the recent access information;
storing the bitmap into a virtual memory; and
controlling the memory device to perform a garbage collection operation according to the bitmap.

10. The method of claim 9, further comprising periodically flushing new map data into the memory device.

11. The method of claim 10, further comprising:
caching the new map data; and
updating the bitmap according to the new map data.

12. The method of claim 9, wherein the bitmap is generated such that the bitmap sets a value of ‘1’ for a valid page.

13. The method of claim 9, further comprising flushing the map data in units of segments.

14. The method of claim 9, wherein the controlling of the memory device to perform a garbage collection operation includes:
selecting a victim memory block, among a plurality of memory blocks of the memory device, having a smaller number of valid pages than a threshold based on the bitmap; and
copying valid data stored in the victim memory block into a free memory block of the plurality of memory blocks.

15. The method of claim 9, wherein the bitmap is generated such that rows of the bitmap respectively correspond to a plurality of memory blocks of the memory device.

16. The method of claim 9, wherein the bitmap is generated such that columns of the bitmap respectively correspond to a plurality of memory blocks of the memory device.

17. A data processing system comprising:
a host including a unified memory (UM); and
a memory system including a controller and a memory device having a plurality of pages,
wherein the unified memory is suitable for storing a bitmap indicating validities of the plurality of pages of a memory device,
wherein the controller includes:
an address manager suitable for storing map data and recent access information corresponding to user data;
a bitmap manager suitable for generating the bitmap indicating whether the plurality of pages are valid based on the map data and the recent access information, and storing the bitmap into the unified memory; and
a processor suitable for controlling the memory device to perform a garbage collection operation according to the bitmap.

18. The data processing system of claim 17, wherein the processor is further suitable for periodically flushing new map data into the memory device.

19. The data processing system of claim 18,
wherein the address manager is further suitable for caching the new map data into therein, and
wherein the bitmap manager is further suitable for updating the bitmap according to the new map data.

20. The data processing system of claim 14, wherein the processor is further suitable for controlling the memory device to:
select a victim memory block, among a plurality of memory blocks of the memory device, having a smaller number of valid pages than a threshold based on the bitmap; and
copy valid data stored in the victim memory block into a free memory block of the plurality of memory blocks.
